(19) United States
(12) Patent Application Publication
(10) Pub. No.: US 2011/0085334 A1
(43) Pub. Date: Apr. 14, 2011

(54) LED illuminating device

(76) Inventor: John Lewis Wang, Walnut, CA (US)

(21) Appl. No.: 12/928,693

(22) Filed: Dec. 15, 2010

Related U.S. Application Data
(63) Continuation-in-part of application No. 12/228,738, filed on Aug. 15, 2008, now Pat. No. 7,887,218.
Application No. 12/228,738 is a continuation-in-part of application No. 11/583,470, filed on Oct. 17, 2006, now abandoned.

(51) Int. Cl. F21S 4/00; B29C 45/14

(52) U.S. Cl. 362/249.02; 264/272.14

(57) ABSTRACT

A LED illuminating arrangement with a plurality of illuminating devices connected in parallel with wires aligned at a one-plane manner. The illuminating device comprises a shell formed by injection molding of ABS plastic, an illuminating unit and a sealing arrangement. The shell has a top side, two sidewalls defining two guiding slots for wires passage and one or more chambers indented from the top side. The illuminating unit includes a printed circuit board and one or more diodes mounted on an exposed portion of the circuit board within the chamber in series for providing illumination. The sealing arrangement is made of thermosetting polymer sealing at each chamber, protecting the diode and the exposed portion of the circuit board against water.

### CROSS REFERENCE OF RELATED APPLICATION

This is a CIP application that claims the benefit of priority under 35 U.S.C. §119 to a non-provisional application, application Ser. No. 12/228,738, filed Aug. 15, 2008, which is a CIP application that claims the benefit of priority under 35 U.S.C. §119 to a non-provisional application, application Ser. No. 11/583,470, filed Oct. 17, 2006.

### BACKGROUND OF THE PRESENT INVENTION

1. Field of Invention

The present invention relates to an illuminating device, and more particularly to a LED illuminating module which is suitable for indoor and outdoor use under all-weather conditions.

2. Description of Related Arts

The Light Emitting Diode (LED) is an excellent luminescence power providing many advantages such as lower power consumption and convenient for use. The LED is a fine cold source that can be a monocolor LED which has been widely utilized all over the world on lights and lanterns including traffic light while the chromatic LED, such as trichromatic LED, has been used in the large screen or electronic billboard for displaying figures or words. The arranged shape of LEDs is a rectangle or mounting different shape according to different pictorial circuit board (PCB board) on the billboard, controlled by special hardware and software. The consumer can take attention to preinstall the picture on the screen. In addition, the LEDs have widely been also utilized in family and something else, such as adornment of Christmas tree, etc.

When the device including traffic light, big screen LED and electronic billboard make use of the conventional LEDs, the conventional LEDs having an electronic billboard are schemed out on the product. However, the drawbacks of the conventional LEDs are inflexibility, uncommonality and convenient limited.

Some inventions provide some LED illuminating device for solving previous problem, such as a Chinese patent CN1191641C which discloses a LED illuminating device comprising an illuminating unit having one or more LEDs and at least one LED chip mounted on a printed board, wherein the LED chip is controlled and driven by a control circuit which is mounted on the printed circuit picture in the circuit board. At least one jack is an electrode terminal of down-lead forming a hollow connecting base pin inserting at least one pylome, regarding as at least one power terminal and a control signal terminal.

The illuminating unit of the LED illuminating device comprising a plurality of LEDs having the same color and forming a LED module electrically connected in series or in parallel. Therefore when multiple colors are needed, many illuminating units should be aligned side by side in a complicated manner.

There is increasing concern that the LED illuminating device is capable of behaving more safety. The conventional LED illuminating device usually comprises a lot of connections between each different LED module. The complicated connection runs through the illuminating unit and the power source may result in high electrical consumption and overheating of the whole LED package. Thus, it will cause a short circuit of the circuit board or device failure. In addition, water and moisture which is usually existed in the environment causes another safety concern of the LED illuminating device.

On the other hand, in recent years, the material cost of the copper has become more and more expensive. The production of the LED illuminating device usually consumes lots of wire material. Thus, it not only increase the manufacturing cost while producing the LED illuminating device, but also leads to a bulky appearance and difficult operation. It is necessary to find a new and cost effective method to produce the LED illuminating device.

### SUMMARY OF THE PRESENT INVENTION

The invention is advantageous in that it provides a LED illuminating device, wherein the blue, green, red wire and the illuminating unit power lines are adapted to electrically link two neighboring LED modules with each other in a flat plane manner so as to eliminate the permanent angle to be extended parallelly from one end of the neighboring LED module to another LED module. In other words, through this method, the elimination of the permanent angle increases the efficiency of assembly because the wire doesn't need to bend. Finally, it reduces unnecessary length of the wire and minimizes the size of the device by decreasing the overall volume.

Another advantage of the invention is to provide a LED illuminating device, wherein the blue, green, red wire and the illuminating unit power lines are adapted to electrically link two neighboring LED modules with each other in a flat plane manner therefore reducing the chance of short-circuits and errors in production.

Another advantage of the invention is to provide a LED illuminating device, wherein the blue, green, red wire and the illuminating unit power lines are adapted to electrically link two neighboring LED modules with each other in a flat plane manner so as to increase the endurance of the LED illuminating device because it doesn't have to bend the wire during assembling and disassembling.

Another advantage of the invention is to provide a LED illuminating device, wherein the blue, green, red wire and the illuminating unit power lines are adapted to electrically link two neighboring LED modules with each other in a flat plane manner so as to reduce the length of the connection and power wire. Thus, it dramatically reduces the material cost when producing.

Another advantage of the invention is to provide a LED illuminating device which is adapted to generating a line of light source from a plurality of discrete points of light sources, so as to enhance the convenient of the operation of the LED illuminating device.

Another advantage of the invention is to provide a LED illuminating device which is adapted to generate a different color source of light, and which is simple in structure and non-fragile, consumes less energy as compared with conventional neon lights and fluorescent lamps, and generates less heat when operating.

Another advantage of the invention is to provide a LED illuminating device comprising many LED illuminating lights connected by four wires including a red wire, a green wire, a blue wire, and a power supply wire so as to optimally control every LED module by corresponding wires.

Another advantage of the invention is to provide a LED illuminating device comprising a waterproof LED illuminating formed by sealed affuseing transparent epoxy between the PCB board and the shell enabling the LED illuminating device to be used in a wide variety of environments and convenient installation.

Another advantage of the invention is to provide a LED illuminating device which does not involve any expensive or complicated electrical or mechanical components so as to minimize the manufacturing cost and the ultimate selling price of the present invention.

Another advantage of the invention is to provide a LED illuminating device using single device or multi-device.

Another advantage of the invention is to provide a LED illuminating device which is to be alternatives to neon lighting so as to provide many advantages such as freight cost reduction and usefulness.

Another advantage of the invention is to provide a LED illuminating device comprising a shell, an illuminating unit and a sealing arrangement in which the illuminating unit is integrally enclosed and protected by the shell and an exposed portion of the illuminating unit which is necessary for communicating with outside for illumination is sealed and protected by the sealing arrangement.

Another advantage of the invention is to provide a LED illuminating device connected with wires comprising a shell, an illuminating unit and a sealing arrangement in such a manner that the LED illuminating device is a waterproof construction and is suitable for indoor and outdoor use.

Another advantage of the invention is to provide a LED illuminating device connected with wires comprising a shell defining a chamber and positing the wires on two sides, an illuminating unit supported and enclosed by the shell and communicating with outside through the chamber of the shell, and a sealing arrangement protecting the illuminating unit inside the chamber of the shell, thereby the illuminating device is a rectangular waterproof structure connected with wires on two sides which is capable of forming a LED illuminating arrangement in the form of a LED strap through connecting a plurality of LED illuminating devices by the wires on the two sides.

Another advantage of the invention is to provide a LED illuminating device which is handy in structure, comprising a mounting unit and an adhesive unit which is capable of providing sufficient support at all angle, making it possible to mount or position the LED illuminating device at any supporting points or surface.

Additional advantages and features of the invention will become apparent from the description which follows, and may be realized by means of the instrumentalities and combinations particular point out in the appended claims.

According to the present invention, the foregoing and other objects and advantages are attained by a LED illuminating device, comprising:

a shell having a top side and a chamber indented in the top side, defining a peripheral wall upwardly extended from a bottom wall of the chamber; and

an illuminating unit comprising a PCB supported by the shell and one or more LED modules electrically and spacedly mounted to the PCB disposed in the chamber, each of the LED modules including a red LED, a blue LED and a green LED which are symmetrically arranged in a triangular manner side by side, two terminals of the PCB being connected with root portions of the wires which includes electrical wires to electrically connect with the red, blue and green LEDs of the LED modules respectively and a power wire for connecting with a power source, wherein the shell is filled with transparent or translucence epoxy resin to cover the PCB, the root portions of electrical and power wires and the chamber to seal the illuminating unit in the shell to form an integral body, wherein the wires are emerged out from two ends of the surrounding side of the LED illuminating device to the another neighboring LED illuminating device. The LED module is adapted for accumulating the LEDs of the illuminators within the chamber, so as to merge the points of light source to form a line of source in the chamber.

Therefore, the PCB has three LED modules connected in series, wherein the LEDs having the same color. Four wires including a red wire, a green wire, a blue wire, and a power supply wire, which are welded at each of the two terminals of the illuminating unit. The red, green and blue wires are electrically connected with the red, green and blue LEDs respectively while the source power wire is electrically with the external power source.

The present invention provides many advantages such as simple frame, freight cost reduction, and lower fault, and it is convenience to operate that different color device attach to control respectively.

In accordance with another aspect of the invention, the present invention provides a LED illuminating device which comprises an illuminating unit, a one piece integrated shell, and a chamber seal.

The illuminating unit comprises a circuit board, one or more diodes electrically mounted on the circuit board, and a plurality of wires electrically extending from two side edges of the circuit board respectively to electrically connect with the diodes.

The shell seals and encloses the illuminating unit to form a waterproof casing of the illuminating unit, wherein the shell has a top side, a bottom side, and one or more chambers indented from the top side to align with the diodes respectively, wherein the shell forms an integrated enclosure to seal the circuit board therewithin at a position that the circuit board is sealed between the top and bottom sides of the shell, and to seal connections between the wires and the circuit board; and

The chamber seal seals at each of the chambers of the shell to seal and enclose the respective diodes therewithin, wherein each the chamber seal protects the corresponding diode within the chamber in a waterproof manner.

Accordingly, the shell has a waterproof construction for protecting the PCB therein, while the sealing arrangement has a waterproof construction for preventing water moisture from the chamber. In other words, the abs molding of the shell and the sealing arrangement creates a water-tight environment for the electrical parts of the LED illuminating device, making it suitable for use under all-weather conditions.

In accordance with another aspect of the invention, the present invention provides a method of manufacture for the LED illuminating arrangement, which is a LED strap, comprising the following steps.

(A) Electrically couple one or more diodes on a circuit board and electrically extending a plurality of wires from the circuit board to electrically link with the diodes in order to form an illuminating unit;

(B) Mold-inject a shell sealing and enclosing the illuminating unit to form a waterproof casing of the illuminating unit, wherein the shell has a top side, a bottom side, and one or more chambers indented from the top side to align with the diodes respectively, wherein the shell forms an integrated enclosure to seal the circuit board therewithin at a position that the circuit board is sealed between the top and bottom sides of the shell, and to seal connections between the wires and the circuit board.

(C) Apply a chamber seal for sealing at each of the chambers of the shell to seal and enclose the respective diodes therewithin, wherein each the chamber seal protects the corresponding diode within the chamber in a waterproof manner.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of a LED illuminating device according to a preferred embodiment of the present invention.

FIG. 2 is a perspective view of the LED illuminating device according to the above preferred embodiment of the present invention.

FIG. 3 is a circuit diagram of the LED illuminating device according to the above preferred embodiment of the present invention.

FIG. 4 is illustrates an alternative mode of the above preferred embodiment of the present invention.

FIG. 5 is a perspective view of a LED illuminating device according to a second preferred embodiment of the present invention.

FIG. 6 is a side view of the LED illuminating device according to the above second preferred embodiment of the present invention.

FIG. 7 is a perspective view of the LED illuminating device according to the above second preferred embodiment of the present invention, illustrating the connection between different LED modules.

FIG. 8 is a perspective view of the LED illuminating device according to a third preferred embodiment of the present invention.

FIG. 9 is an exploded view of the LED illuminating device according to the above third preferred embodiment of the present invention.

FIG. 10 is a top view of the LED illuminating device according to the above third preferred embodiment of the present invention.

FIG. 11 is a sectional view of a cover of the LED illuminating device according to the above third preferred embodiment of the present invention.

FIG. 12 is a sectional view of a supporting base of the LED illuminating device according to the above third preferred embodiment of the present invention.

FIG. 13 is a perspective view of the LED illuminating device according to a fourth preferred embodiment of the present invention.

FIG. 14 is a perspective view of the PCB of the LED illuminating device connected with wires according to the above fourth preferred embodiment of the present invention.

FIG. 15 is a top view illustration of the LED illuminating device connected with wires according to the above fourth preferred embodiment of the present invention.

FIG. 16 is an illustration of the circuit of LED illuminating device according to the above fourth preferred embodiment of the present invention.

FIG. 17 is an illustration of the mounting unit and the adhesive unit of the LED illuminating device connected with wires according to the above fourth preferred embodiment of the present invention.

FIG. 18 is an illustration of the LED arrangement according to the above fourth preferred embodiment of the present invention.

FIGS. 19 to 26 are an illustration of the method of manufacture of the LED arrangement according to the above fourth preferred embodiment of the present invention.

### DETAILED DESCRIPTION OF THE PREFERRED EMBODIMENT

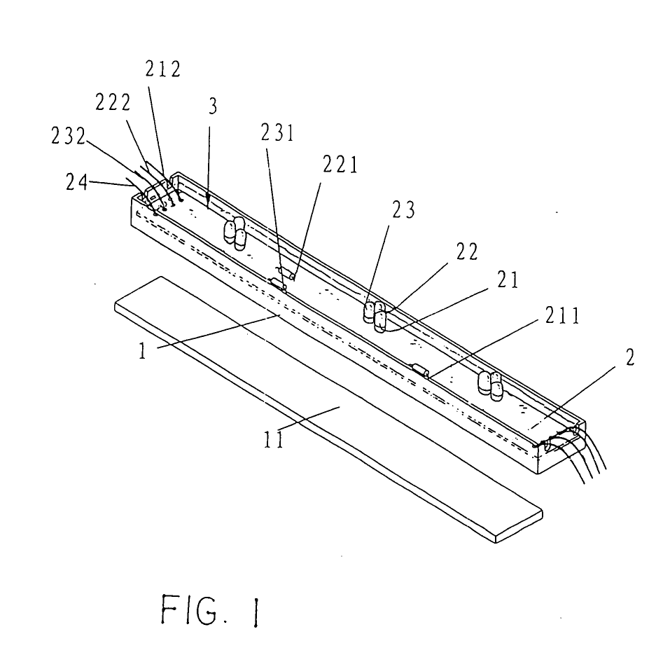

Referring to FIG. 1 to FIG. 3 of the drawings, a LED illuminating device according to a preferred embodiment of the present invention is illustrated, in which the LED illuminating device comprises a shell 1 and an illuminating unit 4.

The shell 1 of salver shape, which is made of non-fragile materials such as plastic materials, has a top side and a chamber 5 indented in the top side, defining a peripheral wall upwardly extended from a bottom wall of the chamber.

The illuminating unit 4 comprises a printed circuit board (PCB) 2 supported by the shell 1 and having one or more LEDs 21, 22 and 23 which are electrically and spacedly mounted on a PCB 2 disposed in the chamber 5. There are three LED modules each comprises a red LED 21, a green LED 22, and a blue LED 23 connected in parallel with one another. In other words, the red, blue and green LEDs 21, 22, 23 of each of the LED modules are connected with one another in serial manner. Alternatively, each LED module may include a red LED 21 and a green LED 22 connected in series while connecting a blue LED 23 in parallel. Therefore each LED module is adapted for accumulating the LEDs of the illuminators within the chamber 5, so as to merge points of light source to form a line of lighting in the chamber.

Each of the two terminals the PCB 2 is electrically connected by welding with four wires, generally including a red wire 212, a green wire 222, a blue wire 232, and a power wire 24, wherein the red wire 212, the green wire 222 and the blue wire 232 are connected with the red LED 21, the green LED 22 and the blue LED 23 respectively while the power line 24 is adapted for connecting to a power source.

More specifically, four wires are controlled in beneficial to collocation and in different color LEDs, wherein four wires standing each of the two terminals of the PCB 2 lead-out from two ends of the top side of the shell 1.

Moreover, the red LED 21, the green LED 22 and the blue LED 23 match respectively a red resistance Rr211, a green resistance Rg221 and a blue resistance Rb231. The red LED 21, the green LED 22 and the blue LED 23 is preferably arranged in a triangular manner side by side. The shell is preferred to be made of PVC material. The height of the three-color LEDs 21, 22, 23 is designed to be higher than top of the shell 1. The back side of the shell 1 provides an adhesive layer 11 for attaching with other surfaces or that two sides of the shell 1 can be mounted in a protruding auricular mode for connecting with others.

It is worth mentioning that the LED illuminating device is constructed to form a waterproof structure by means of the affuseing transparent epoxy resin 3 filled in the shell 1 to sealedly envelope the printed circuit board (PCB) 2, the connections of the root portions of the wires 212, 222, 232, 24 with the terminals of the PCB 2, and the chamber of the shell 1. In addition, the wires 212, 222, 232, 24 are permanently angled to be extended parallelly from the ends of the shell 1 to another neighboring LED illuminating devices, wherein the epoxy resin 3 substantially affirms the inclined angle of the root portions so as to ensure the wires extending transversally from the shell.

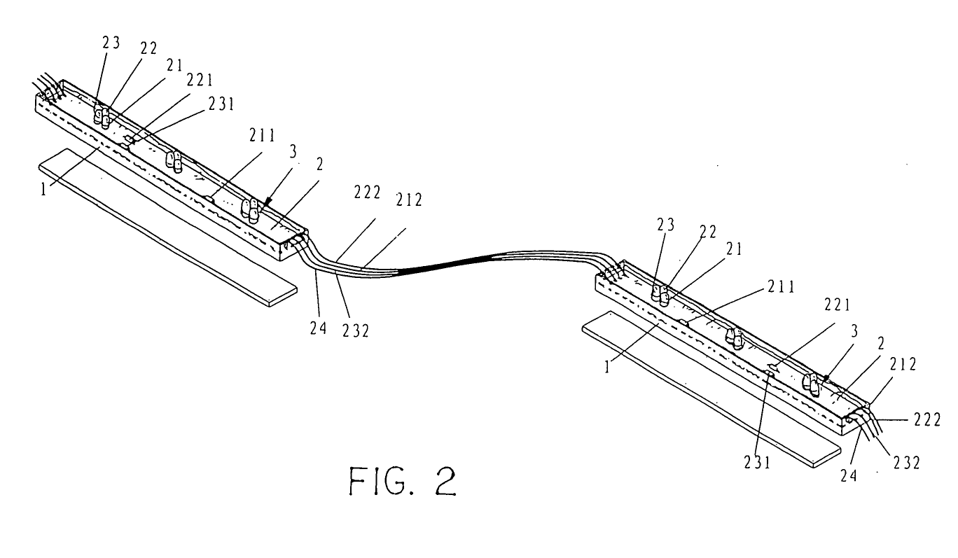

Referring to FIG. 2 of the drawings, a chain of LED illuminating devices is generally provided by simply connecting the LED illuminating devices with the wires 212, 222, 232, 24 in series. The user can cut off any set of connecting wires 212, 222, 232, 24 to obtain the desired length and number of LED illuminating devices for different applications.

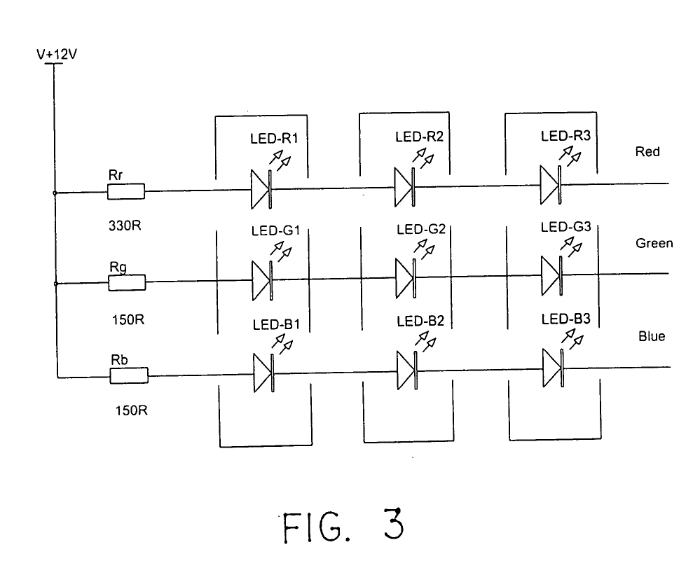

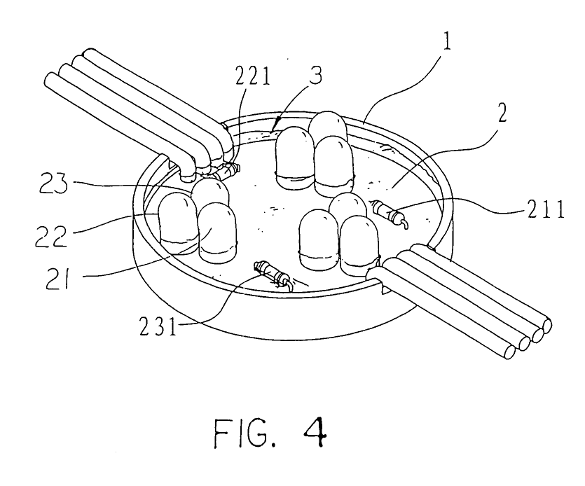

Referring to FIG. 4, an alternative mode of the LED illuminating device according to the preferred embodiment of the present invention illustrates an illuminating chain in series, wherein the three LED modules are arranged in a circular shell 1 with the same circuit arrangement as shown in FIG. 3.

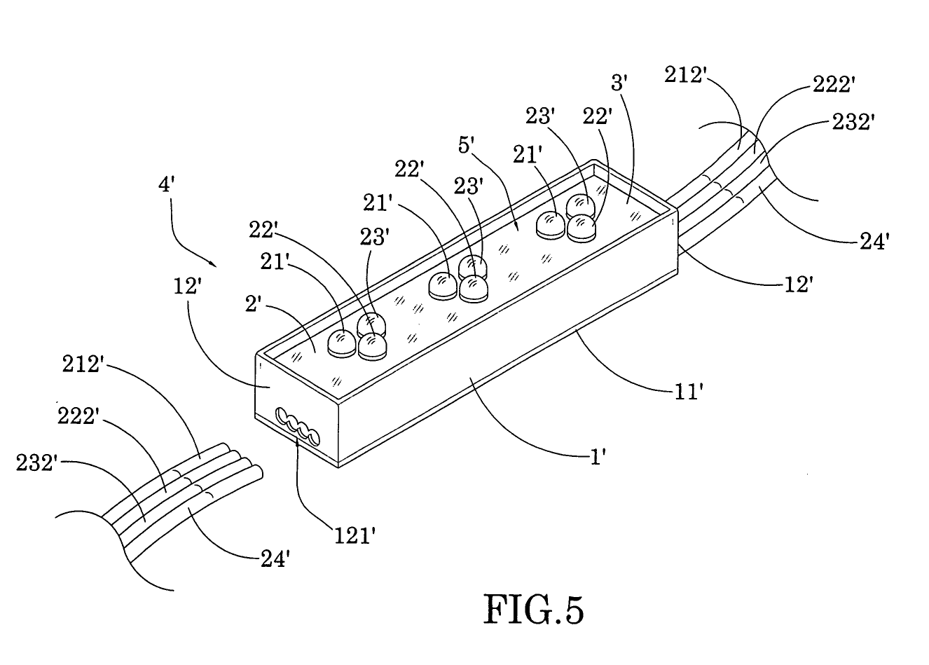

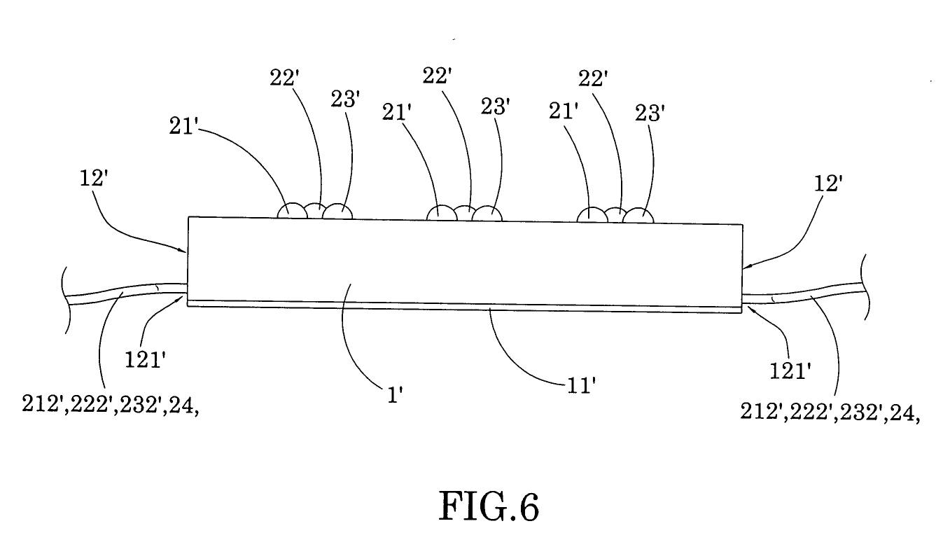

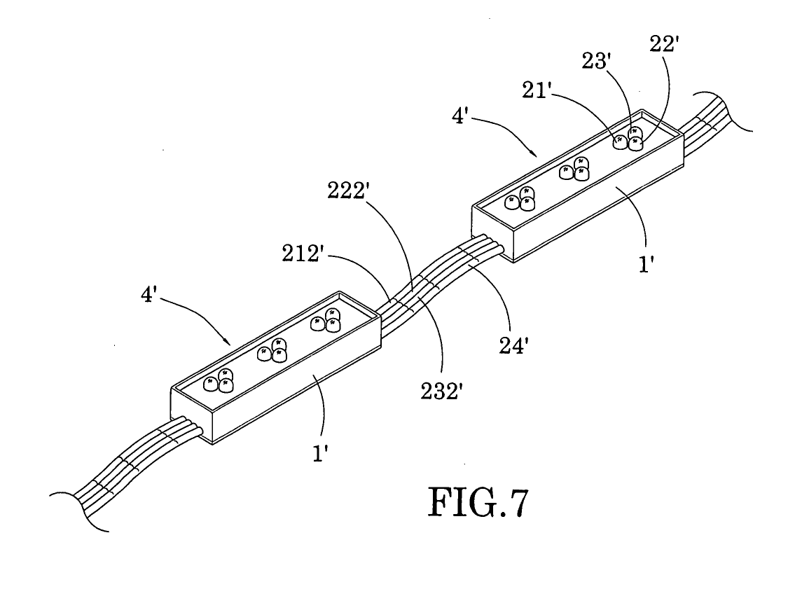

Referring to FIG. 5 to FIG. 7 of the drawings, a LED illuminating arrangement according to a preferred embodiment of the present invention is illustrated, wherein the LED illuminating arrangement comprises a plurality of LED illuminating devices connected with wires. Each of the LED illuminating devices comprises a shell 1′ and an illuminating unit 4′.

The shell 1′ of salver shape, which is made of non-fragile materials such as plastic materials, has a top side and a chamber 5′ indented in the top side, defining a peripheral wall upwardly extended from a bottom wall of the chamber.

The illuminating unit 4′ comprises a printed circuit board (PCB) 2′ supported by the shell 1′ and having one or more LEDs 21′, 22′ and 23′ which are electrically and spacedly mounted on a PCB 2′ disposed in the chamber 5′. There are three LED modules each comprises a red LED 21′, a green LED 22′, and a blue LED 23′ connected in parallel with one another. In other words, the red, blue and green LEDs 21′, 22′, 23′ of each of the LED modules are connected with one another in serial manner. Alternatively, each LED module may include a red LED 21′ and a green LED 22′ connected in series while connecting a blue LED 23′ in parallel. Therefore each LED module is adapted for accumulating the LEDs of the illuminators within the chamber, so as to merge points of light source to form a line of lighting in the chamber 5′.

Each of the two terminals the PCB 2′ is electrically connected by welding with four wires, generally including a red wire 212′, a green wire 222′, a blue wire 232′, and a yellow power wire 24′, wherein the red wire 212′, the green wire 222′ and the blue wire 232′ are connected with the red LED 21′, the green LED 22′ and the blue LED 23′ respectively while the power line 24′ is adapted for connecting to a power source.

More specifically, four wires are controlled in beneficial to collocation and in different color LEDs, wherein four wires standing each of the two terminals of the PCB 2′ lead-out from two ends of the surrounding side of the shell 1′.

Moreover, the red LED 21′, the green LED 22′ and the blue LED 23′ match respectively a red resistance, a green resistance and a blue resistance which are coupled underneath the PCB 2′. The red LED 21′, the green LED 22′ and the blue LED 23′ are preferably arranged in a triangular manner side by side. The shell 1′ is preferred to be made of PVC material. The height of the three-color LEDs 21′, 22′, 23′ is designed to be higher than top of the shell 1′. The back side of the shell 1′ provides an adhesive layer 11′ for attaching with other surfaces or that two sides of the shell 1′ can be mounted in a protruding auricular mode for connecting with others. Therefore, the LED illuminating devices are adapted for being selectively mounted on the mounting surface at different orientations while being electrically connected through the wires. In other words, two LED illuminating devices can be mounted to the mounting surface at 90° orientation without affecting the electrical connection between the LED illuminating devices.

As shown in second preferred embodiment of the drawing as shown in FIG. 5, the LED illuminating device is constructed to form a waterproof structure by means of the affuseing transparent epoxy resin 3′ filled in the shell 1′ to sealedly envelope the printed circuit board (PCB) 2′, the terminals of the PCB 2′, and the chamber 5′ of the shell 1′.

According to the second preferred embodiment of the present invention, the wires 212′, 222′, 232′, 24′ are now emerge from two ends of the shells 1′ in a horizontal plane parallel to an adhesive layer 11′ so as to adapt for electrically linking two neighboring LED modules with each other in a flat plane manner.

As shown in FIG. 5, the peripheral wall of the shell 1′ comprises two spaced apart sidewalls 12′, as the peripheral wall, to define the chamber 5′ therebetween, wherein each of the sidewalls 12′ has a plurality of guiding holes 121′ spacedly formed thereat for the wires 212′, 222′, 232′, 24′ sidewardly extending out of the chamber 5′ through the guiding holes 121′ respectively. The three LED modules are alignedly coupled at the PCB 2′ along the shell 1′ between the two sidewalls 12′ thereof.

Accordingly, there are four guiding holes 121′ spacedly formed at each of the sidewalls 12′ such that the four wires 212′, 222′, 232′, 24′ are extended out of the chamber 5′ after the wires 212′, 222′, 232′, 24′ are electrically coupled with the PCB 2′. In particularly, the guiding holes 121′ are formed at the bottom portion of the respective sidewall 12′ to provide a low profile of the LED illuminating device.

As shown in FIG. 5, the guiding holes 121′ are aligned side-by-side and are communicated with each other to form a teeth-shaped guiding channel for the wires 212′, 222′, 232′, 24′ extending out of the chamber 5′. In addition, the teeth-shaped guiding channel is adapted to securely retain the wires 212′, 222′, 232′, 24′ in position so as to prevent the unwanted movement of each of the wires 212′, 222′, 232′, 24′ with respect to the shell 1′.

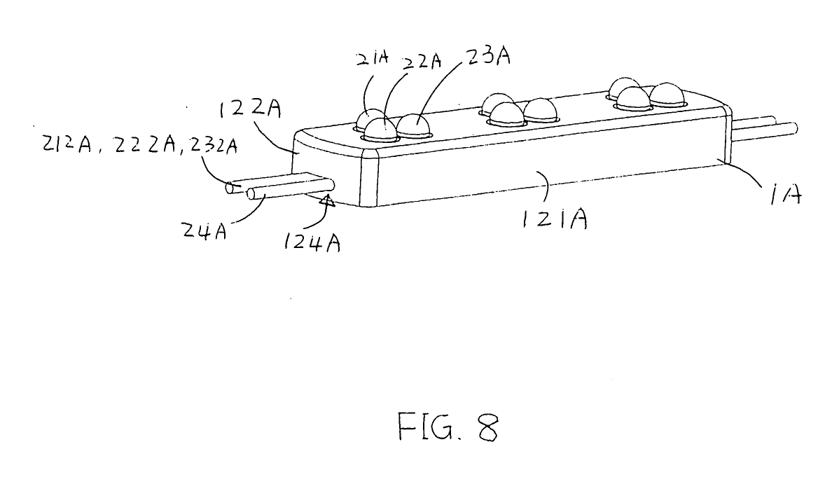

Referring to FIGS. 8 to 10 of the drawings, a LED illuminating arrangement according to a third embodiment of the present invention is illustrated, wherein the LED illuminating arrangement comprises a plurality of LED illuminating devices connected with wires. Each of the LED illuminating devices comprises a shell 1A and an illuminating unit 4A.

The shell 1A, which is made of non-fragile materials such as plastic materials, comprises a supporting base 11A and a cover 12A engaging with the supporting base 11A to define a chamber 5A within the supporting base 11A and the cover 12A.

The illuminating unit 4A comprises a printed circuit board (PCB) 2A supported by the supporting base 11A of the shell 1A and having one or more LEDs 21A, 22A and 23A which are electrically and spacedly mounted on a PCB 2A disposed in the chamber 5A. There are three LED modules each comprises a red LED 21A, a green LED 22A, and a blue LED 23A connected in parallel with one another. In other words, the red, blue and green LEDs 21A, 22A, 23A of each of the LED modules are connected with one another in serial manner. Alternatively, each LED module may include a red LED 21A and a green LED 22A connected in series while connecting a blue LED 23A in parallel. Therefore each LED module is adapted for accumulating the LEDs of the illuminators within the chamber 5A, so as to merge points of light source to form a line of lighting in the chamber 5A.

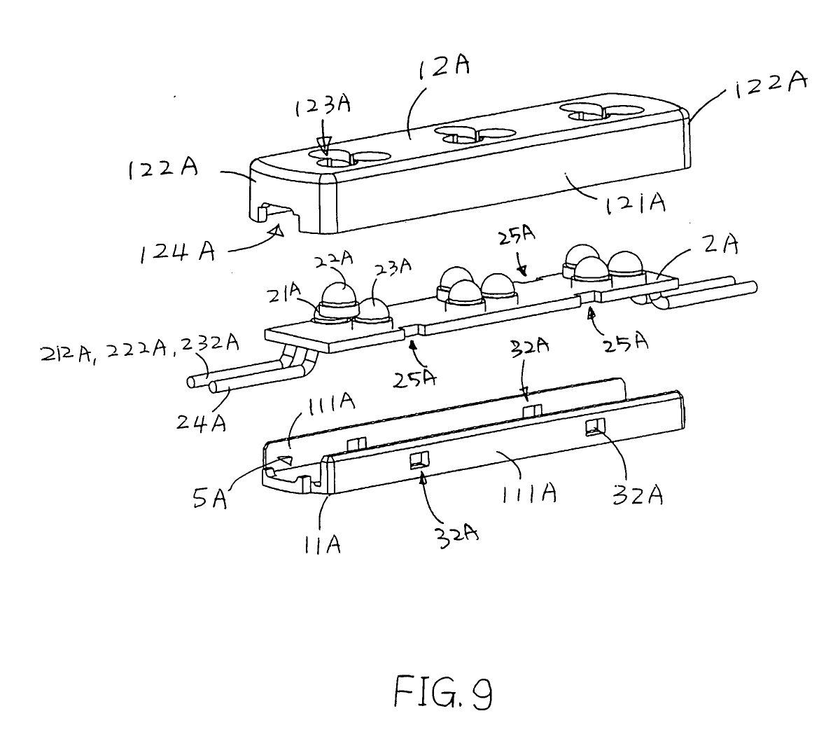

Each of the two terminals the PCB 2A is electrically connected by welding with four wires, generally including a red wire 212A, a green wire 222A, a blue wire 232A, and a power wire 24A, wherein the red wire 212A, the green wire 222A and the blue wire 232A are connected with the red LED 21A, the green LED 22A and the blue LED 23A respectively while the power line 24A is adapted for connecting to a power source. Accordingly, the red wire 212A, a green wire 222A, a blue wire 232A are constructed to form in one wire structure to minimize the wires being tangled with each other as shown in FIGS. 8 and 9.

More specifically, four wires are controlled in beneficial to collocation and in different color LEDs, wherein four wires standing each of the two terminals of the PCB 2A lead-out from two ends of the surrounding side of the shell 1A.

Moreover, the red LED 21A, the green LED 22A and the blue LED 23A match respectively a red resistance, a green resistance and a blue resistance which are coupled underneath the PCB 2A. The red LED 21A, the green LED 22A and the blue LED 23A are preferably arranged in a triangular manner side by side. The shell 1A is preferred to be made of PVC material. The height of the three-color LEDs 21A, 22A, 23A is designed to be protruded out and higher than the cover 12 of the shell 1A. The back side of the shell 1A provides an adhesive layer for attaching with other surfaces or that two sides of the shell 1A can be mounted in a protruding auricular mode for connecting with others. Therefore, the LED illuminating devices are adapted for being selectively mounted on the mounting surface at different orientations while being electrically connected through the wires. In other words, two LED illuminating devices can be mounted to the mounting surface at 90° orientation without affecting the electrical connection between the LED illuminating devices.

As shown in FIG. 9, the supporting base 11A of the shell 1A comprises two spaced apart base sidewalls 111A. The cover 12A of the shell 1A comprises two spaced apart cover sidewalls 121A, two cover end walls 122A, and a top side of the cover 12A having a plurality of through slots 123A for the LEDs protruding out of the shell 1A as shown in FIG. 10, wherein the supporting base 11A and the cover 12A couple with each other by a lid manner and formed the chamber 5A therebetween. In other words, the cover sidewalls 121A of the cover 12A are overlapped at the outer sides of the base sidewalls 111A of the supporting base 11A when the cover 12A engages with the supporting base 11A to enclose the chamber 5A.

Each of the cover end walls 122A has a guiding slot 124A formed thereat for the wires 212A, 222A, 232A, 24A sidewardly extending out of the chamber 5A through the guiding slots 124A respectively. The three LED modules are alignedly coupled at the PCB 2A within the supporting base 11A and the cover 12A of the chamber 5A therein.

Referring to FIGS. 11 and 12, the sectional view of the cover 12A and the supporting base 11A of the shell 1A are illustrated, wherein the cover 12A of the shell 1A has a plurality of locking flanges 31A provided at the inner side of the cover sidewalls 121A of the cover 12A, and the supporting base 11A of the shell 1A has a plurality of locking slots 32A provided at the base sidewalls 111A, so that the locking flanges 31A of the cover 12A engage with the locking slots 32A of the supporting base 11A to form a locking unit 30A to interlock the supporting base 11A with the cover 12A, such that the cover 12A and the supporting base 11A of the shell 1A couple with each other to form the chamber 5A for supporting the illuminating unit 4A.

As shown in FIG. 9, the PCB 2A further has a plurality of cutout portions 25A provided along two side edges of the PCB 2A to align with the locking flanges 31A such that when the PCB 2A is received in the chamber 5A, the locking flanges 31A are engaged with the locking slots 32A through the cutout portions 25A to retain the PCB 2A in position.

Accordingly, there are at least two spaced apart guiding slots 124A formed at each of the cover end walls 122A such that the four wires 212A, 222A, 232A, 24A are extended out of the chamber 5A after the wires 212A, 222A, 232A, 24A are electrically coupled with the PCB 2A. In particularly, the guiding slots 124A are formed at the bottom portion of the respective the cover end walls 122A to provide a low profile of the LED illuminating device.

In the first embodiment of the present invention, the required permanently angled wire increases the length of wire needed. According to the second preferred embodiment of the present invention, the blue, green, red wire, and the illuminating unit power lines are adapted to electrically link two neighboring LED modules with each other in a flat plane manner. In other words, through this method, the elimination of the permanent angle increases the efficiency of assembly because the wire doesn't need to bend. Finally, it reduces unnecessary length of the wire and minimizes the size of the device by decreasing the overall volume.

It is worth mentioning that a flat plane manner method to connect different LED modules eliminates the length of the connection wire and the power wire so as to save lots of material cost when producing. Moreover, such an easy, shorter connection between different modules also reduces the chance of shortcuts and errors. Most important of all, flat plane connection wires between the LED modules instead of permanently angled wires makes the LED module more stable and safe. The conventional LED module usually comprises a complicated connection between the illuminating unit 4 and the power source which is resulted in high electrical consumption and overheating of the whole LED package. The flat plane connection wires between LED modules do not need any bend and cross over to each other so as to provide the most easy and shortest way to transfer the power. Thus, it is easy for people to assemble and disassemble and dramatically reduces the chance of short-circuits.

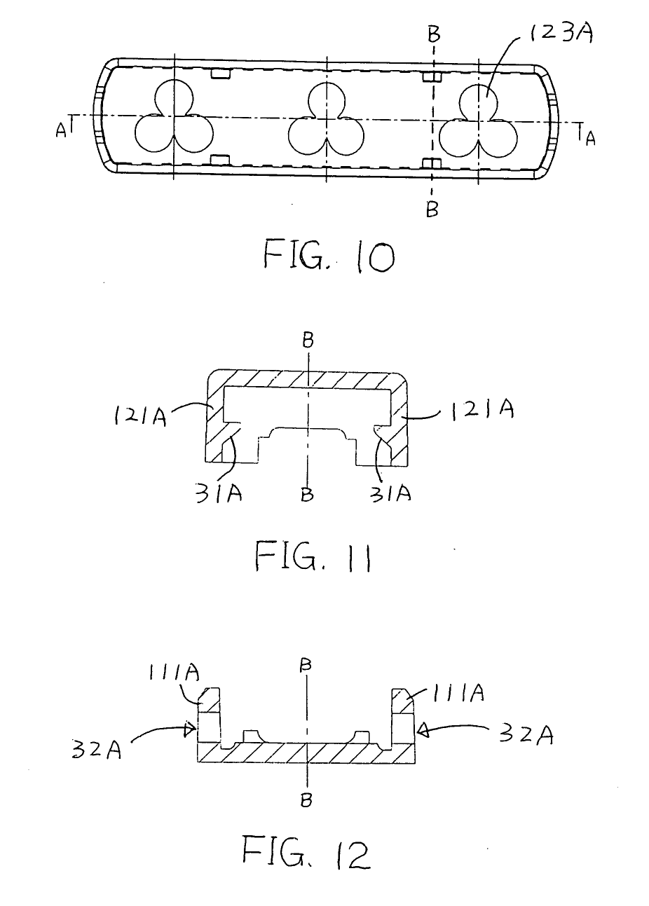

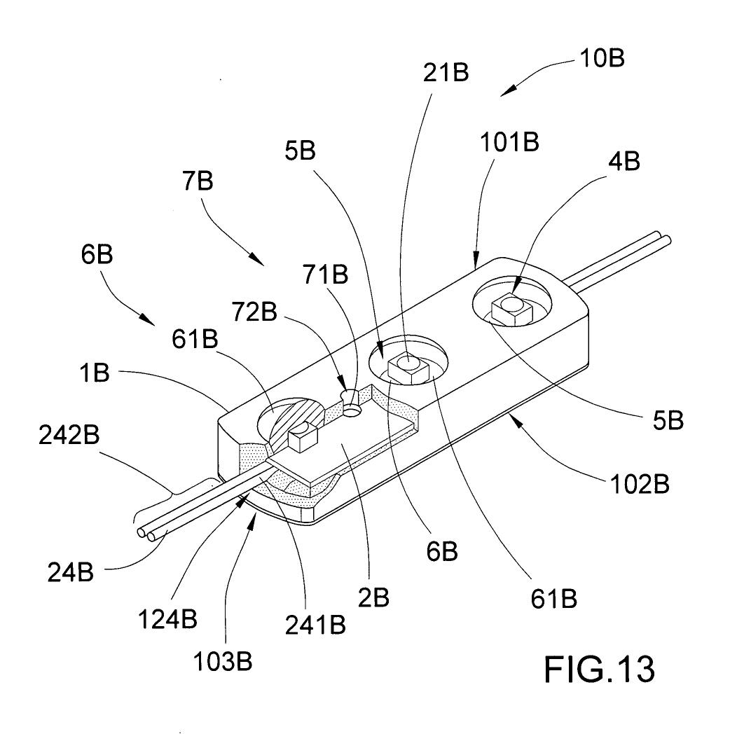

Referring to FIGS. 13 to 18 of the drawings, a LED illuminating arrangement according to a fourth embodiment of the present invention is illustrated, wherein the LED illuminating arrangement comprises a plurality of LED illuminating devices connected with wires 24B. Each of the LED illuminating devices comprises a shell 1B, an illuminating unit 4B and a sealing arrangement 6B.

The shell 1B is made of non-fragile materials such as plastic materials. Preferably, the shell 1B is a one-piece structure of ABS plastic which is formed by injection molding. Alternately, the shell 1B can also be a multi-unit structure of plastic materials. Accordingly, the shell 1B is a rectangular block structure to enclose the illuminating unit 4B.

In particular, the shell 1B has a top side 101B, a bottom side 102B, two sidewalls 103B, two guiding slots 124B provided on the two sidewalls 103B for wires 24B passing through, and one or more chambers 5B. The chamber 5B is indented from the top side 101B towards the bottom side 102B to define a peripheral wall of the chamber 5B.

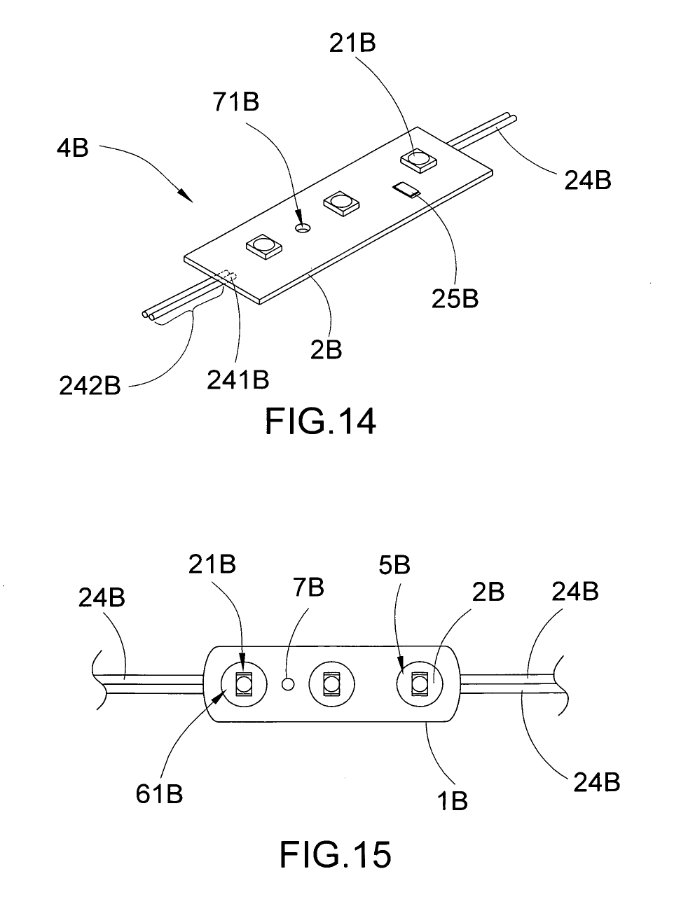

The illuminating unit 4B comprises a printed circuit board (PCB) 2B and one or more LEDs 21B electrically and spacedly mounted on the circuit board 2B, as shown in FIG. 14. The LED 21B is a diode directly and electrically connected to and mounted onto the circuit board 2B. In particular, the circuit board 2B has an enclosed portion sealed by the shell 1B and one or more exposed portions for the diodes 21B electrically mounting thereat respectively. The exposed portions of the circuit board 2B are aligned with the chamber 5B of the shell 1B such that the diodes 21B are located at the exposed portions of the circuit board 2B within the chambers 5B of the shell 1B, as shown in FIG. 15. The illuminating unit 4B further comprises two sets of terminals on two sides of the circuit board 2B respectively for electrically connecting the diodes 21B to a power source through the wires 24B. In particular, the wires 24B are electrically extending from two side edges of the circuit board 2B respectively to electrically connect with the diodes 21B.

As shown in FIG. 13, the shell 1B seals and encloses the illuminating unit 4B to form a waterproof casing of the illuminating unit 4B, wherein the chambers 5B are indented from the top side 101B to align with the diodes 21B respectively. Accordingly, the shell 1B forms an integrated enclosure to seal the circuit board 2B therewithin at a position that the circuit board 2B is sealed between the top and bottom sides 101B, 102B of the shell, and to seal connections between the wires 24B and the circuit board 2B.

According to the preferred embodiment, the shell 1B is mold-injected to the illuminating unit 4B that the upper portion of the shell 1B is sealed and overlapped on the top side of the circuit board 2B and the bottom portion of the shell 1B is sealed and overlapped on the bottom side of the circuit board 2B in order to seal and enclose the circuit board 2B. In other words, there is no clearance or space within the shell 1B for the circuit board 2B being moved to prevent any movement of the circuit board 2B within the shell 1B. Therefore, the circuit board 2B is securely sandwiched between the upper and bottom portions of the shell 1B after the mold injection process of the shell 1B, so as to enhance the durability of the LED illuminating device. Accordingly, the size of the shell 1B can be further minimized with respect to the circuit board 2B. In other words, unlike the conventional LED device, the casing thereof must have receiving space to receive the PCB therein such that the casing of the conventional LED device will have relatively larger size.

It is worth mentioning that the illuminating unit 4B is enclosed and protected by the shell 1B except that the diodes 21B and the exposed portions of the circuit board 2B. In other words, except that the exposed portion of the circuit board 2B, which is the bottom wall of the chamber 5B, all other parts of the circuit board 2B, which is defined as the enclosed portion, are enclosed by the shell 1B.

As shown in FIGS. 13 and 14, each of the wires 24B has a sealing portion 241B extending from the bottom side of the circuit board 2B and being sealed by the shell 1B, and an extending portion 242B extending out of the shell 1B to either connect with another adjacent LED illuminating device or the power source. Accordingly, when the circuit board 2B is sealed and enclosed by the shell 1B, the sealing portions 241B of the wires 24B are also fitted within and sealed by the shell 1B at the sidewall 103B thereof to ensure the connections between the wires 24B and the circuit board 2B. Accordingly, after the mold injection of the shell 1B, the sidewalls 103B of the shell 1B are formed that the guiding slots 124B are integrally and inherently formed at the sidewalls 103 to guide the wires 24B through the guiding slots 124B. In other words, the guiding slots 124B are formed during the mold injection of the shell 1B, which further enhances the protection against water or other external substances.

Accordingly, the shell 1B has a waterproof construction for protecting the circuit board 2B therein, while the sealing arrangement 6B has a waterproof construction for preventing water moisture from the chamber 5B. In other words, the abs molding of the shell 1B and the sealing arrangement 6B creates a water-tight environment for the electrical parts of the LED illuminating device, making it suitable for use under all-weather conditions.

The sealing arrangement 6B comprises a chamber seal 61B for each chamber 5B so that the shell 1B is waterproof. In particular, the chamber seal 61B seals at each of the chambers 5B of the shell 1B to seal and enclose the respective diodes 21B therewithin, wherein each chamber seal 61B protects the corresponding diode 21B within the chamber 5B in a waterproof manner.

In particular, the chamber seal 61B is provided to seal at the chamber 5B from on the bottom wall of the chamber 5B, i.e. the top side of the circuit board 2B, in such a manner that the diode 21B, the exposed portion of the circuit board 2B and the junction between the top side of the circuit board 2B and the peripheral wall of the chamber 5B are shielded against water or external substances. In other words, the chamber seals 61B not only seal at the chambers 5B to enclose the diodes 21B therewithin but also seal at the exposed portions of the circuit board 2B to protect the exposed portions thereof in a waterproof manner.

Preferably, the chamber seal 61B is made of transparent thermosetting polymer such as epoxy or resin. Accordingly, the illuminating device is waterproof, which is suitable for use under all-weather conditions. It is worth mentioning that when the illuminating device is used for outdoor decoration at the time of Christmas or other occasions, the sealing arrangement 6B protects the illuminating device against rain, hail, snow or storm. The waterproof feature not only increases the durability of the illuminating device of the present invention, but also eliminates the safety hazard in relation to short circuit due to moisture intrusion. As a result, the illuminating device of the present invention is energy saving, safe and durable, which is ideal for use under all weather conditions.

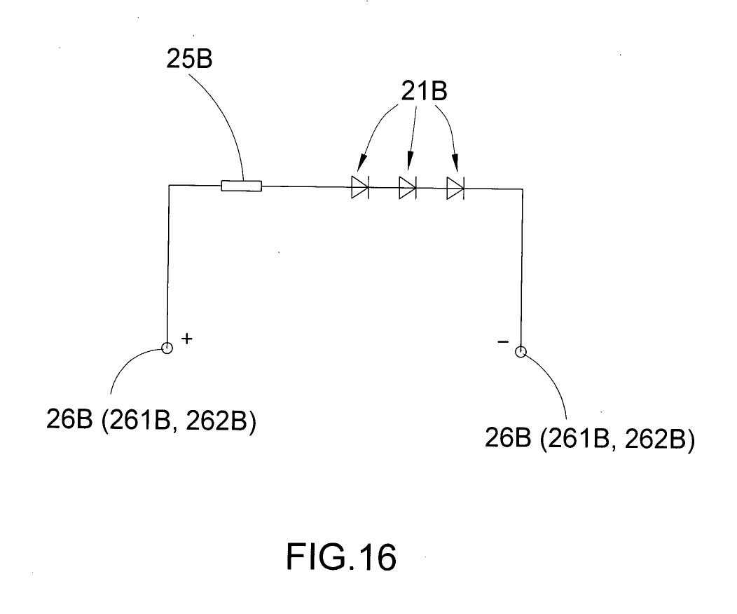

Each set of the terminals 26B, as shown in FIG. 16, include a first terminal 261B and a second terminal 262B of different polarity aligned in a frontward and backward manner respectively at one plane, therefore, the two wires 24B connecting to the first and second terminals 261B, 262B are aligned in a corresponding frontward and backward manner. In other words, the two wires 24B of the one set of wires are aligned in parallel and extended outwardly from the shell 1B through the guiding slot 124B of the corresponding sidewall 103B. Preferably, the two wires 24B connecting to the first and the second terminals 261B, 262B are of different color to represent different polarity of the corresponding terminals 26B (261B, 262B). When two of the LED illuminating devices 10B are connected with one set of wires 24B, the two LED illuminating devices 10B are connected in parallel while the first and the second terminals 261B, 262B of the two different LED illuminating devices 10B are aligned frontwardly and backwardly in the same manner. The first and the second terminals 261B, 262B are two opposite terminals. When the first terminal 261B is a positive terminal, the second terminal 262B is a negative terminal. When the first terminal 261B is a negative terminal, the second terminal 262B is a positive terminal.

It is worth mentioning that a depth of the chamber 5B is approximately the same as a height of the corresponding diode 21B inside the chamber 5B. Accordingly, each diode 21B is well received within the chamber 5B and is not substantively protruded outside the chamber 5B while each chamber seal 61B of the corresponding diode 21B is provided within the corresponding chamber 5B. Preferably, the entire chamber 5B is filled with the chamber seal 61B to enclose the diode 21B within the chamber seal 61B.

Referring to FIG. 13 of the drawings, the LED illuminating device 10B further comprises a mounting unit 7B for mounting the LED illuminating device 10B at a desired object. The mounting unit 7B has a through hole 71B formed at the circuit board 2B, wherein the through hole 71B is extended through the circuit board 2B at the enclosed portion thereof. The mounting unit 7B further has a mounting slot 72B formed at the shell 1B, wherein the mounting slot 72B is extending from the top side 101B of the shell 1B to the bottom side 102B thereof and is aligning with the through hole 71B at the circuit board 2B when the circuit board 2B is sealed between the top and bottom sides of the shell 1B.

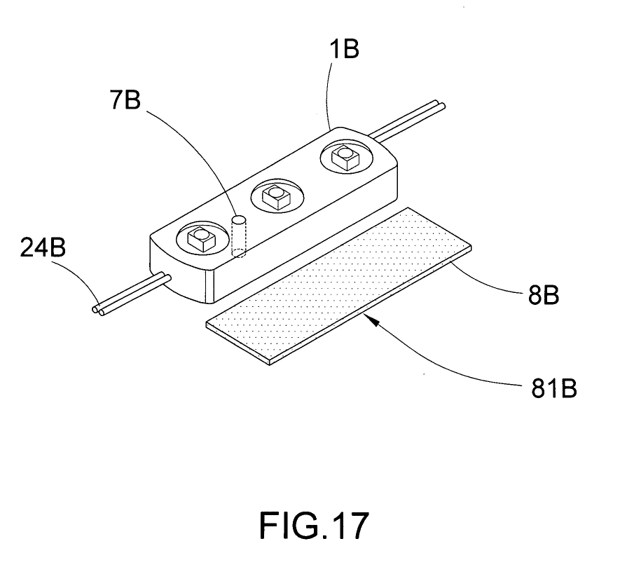

Accordingly, a user can simply use a screw to mount the LED illuminating device 10B onto a wall or the like through the mounting unit 7B by passing the screw along the mounting slot 72B through the mounting hole 71B. Preferably, referring to FIG. 17 of the drawings, the LED illuminating device 10B further comprises an adhesive unit 8B provided on the flat bottom surface of the bottom side 102B of the shell 1B which has an adhesive surface 81B. Accordingly, a user can simply make use of the adhesive surface 81B for setting the LED illuminating device 10B into position. In other words, the LED illuminating device 10B can be set into position through the mounting unit 7B or the adhesive unit 8B, either through mounting or adhesion, regardless of the limitation of the supporting object of the illuminating unit 4B existed in the environment. For example, the user can use the mounting unit 7B for hanging up the LED illuminating device 10B, or use a screw to affix the LED illuminating device 10B, or put the LED illuminating device 10B onto a wall through the adhesive surface 81B of the adhesive unit 8B.

Referring to FIGS. 14 and 16 of the drawings, preferably, the three diodes 21B on the circuit board 2B are connected in series and a resistance 25B is included in the circuit of the circuit board 2B. It is worth mentioning that three diodes 21B, i.e. red diode, blue diode, and green diode, can be symmetrically arranged in a triangular manner side by side on the circuit board 21B, wherein the three diodes 21B are located within one chamber 5B and are sealed by one chamber seal 61B.

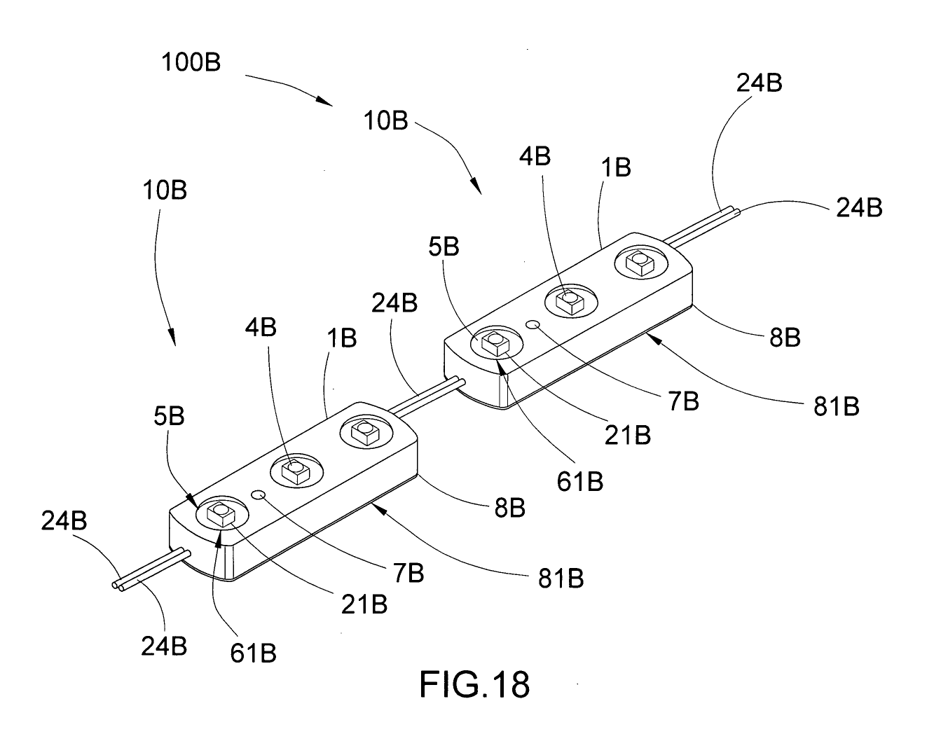

Referring to FIG. 18 of the drawings, each two of the LED illuminating devices 10B are connected and electrically connected by wires 24B such that a plurality of LED illuminating devices 10B can be connected to form a LED strap. In other words, a LED strap of any length can be provided through the construction of the LED illuminating arrangement of the present invention. Accordingly, the LED strap can be used to match Christmas tree of different sizes, houses of different dimensions, etc. or the LED strap itself can be used to tie or hang around an affixing object, providing the user further flexibility and convenience. In other words, the user can simply make use of the strap-like structure of the LED illuminating devices 10B, the LED strap, to affix or tie the LED illuminating devices to any affixing object.

It is worth mentioning that the plurality of LED illuminating devices 10B are connected in parallel by the wires 24B. Accordingly, the length of the LED strap can be adjusted simply by cutting the wires between two LED illuminating devices 10B without affecting the electrical connection between different LED illuminating devices 10B. In other words, a roll of LED strap can be provided by the present invention, which is arranged for providing a LED strap of a predetermined length as desired by the user. Likewise, two different LED straps can be connected simply by connecting the corresponding wires.

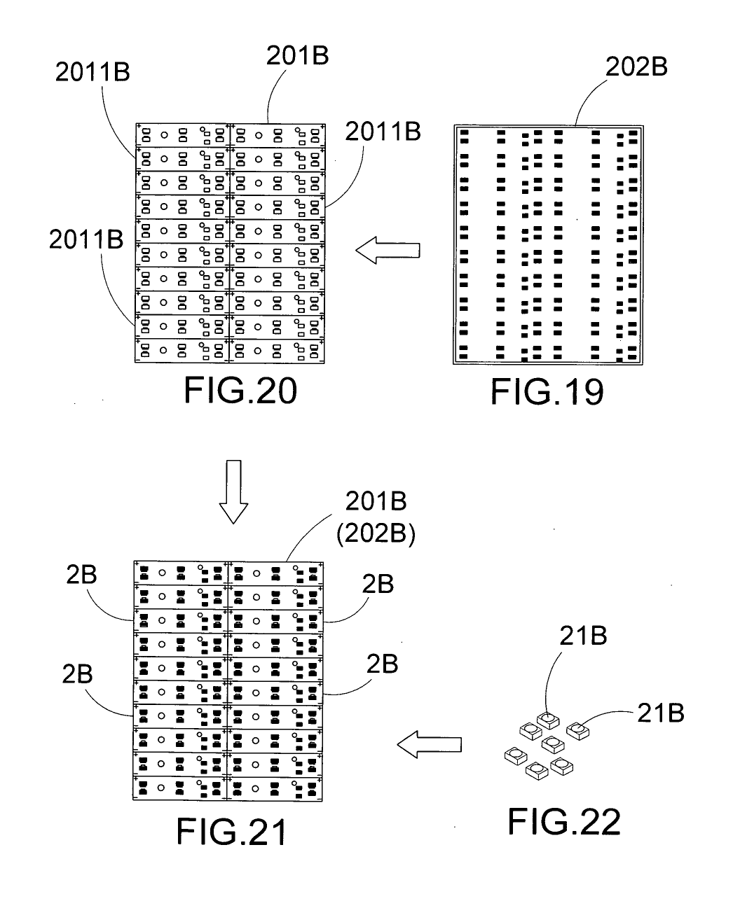

Referring to FIGS. 19 to 26 of the drawings, a method of manufacture for the LED illuminating arrangement, which is a LED strap 100B, according to the fourth embodiment of the present invention is illustrated. The method comprises the following steps.

(1) Electrically couple one or more diodes 21B on the circuit board 2B and electrically extend the wires 24B from the circuit board 2B to electrically link with the diodes 21B in order to form the illuminating unit.

In the step (1), a LED integrated circuit board 201B is provided, wherein the LED integrated circuit board 201B has a preset longitudinal cutting line and a preset series of latitudinal cutting lines such that a preset number of LED integrated circuit board unit 2011B is defined, wherein each of the LED integrated circuit board unit 2011B has a plurality of preset soldering points, which is shown in FIG. 20.

A LED frame board 202B is provided, such as a LED steel board, and is sized to fit the LED integrated circuit board 201B and having a plurality of soldering windows corresponding to the position of the soldering points of the LED integrated circuit board unit 2011B respectively, which is shown in FIG. 19.

The LED frame board 202B is placed on top of the LED integrated circuit board 201B and is aligned into position such that the soldering points of the LED integrated circuit board 201B are exposed through the soldering windows of the LED frame board 202B respectively, which is shown in FIG. 21.

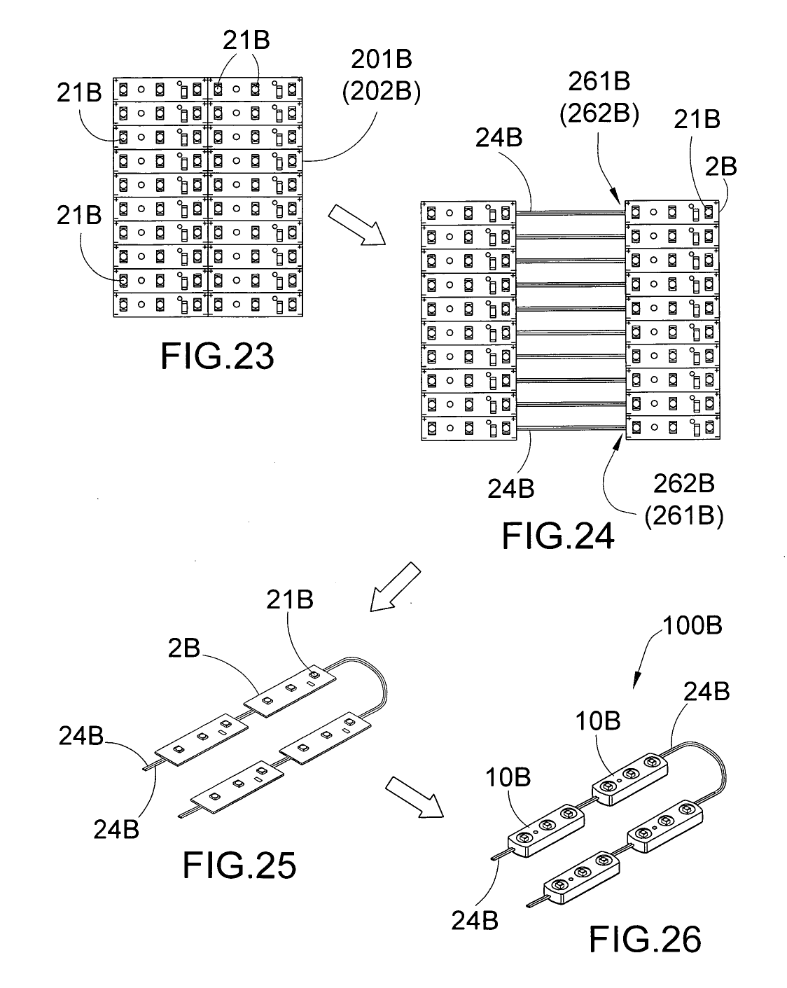

Solder paste is applied to the soldering points and reflow soldering a plurality of diodes 21B, as shown in FIG. 22, onto the soldering points of the LED integrated circuit board 201B, thereby a plurality of illuminating units 4B are formed, which is shown in FIG. 23.

The plurality of illuminating units 4B is separated by cutting along the preset longitudinal cutting line and connecting the illuminating units 4B on two sides of the longitudinal cutting line by a set of wires 24B, wherein the set of wires 24B comprises two wires of different color for the two opposite terminals 26B of the illuminating unit 4B.

The illuminating units 4B separated by cutting along the preset series of latitudinal cutting lines.

A PCB strap is formed by connecting the plurality of illuminating units 4B by wires, as shown in FIG. 25.

According to the step (1), the circuit board 2B is configured to have the enclosed portion arranged to be sealed by the shell and the exposed portions for the diodes 21B electrically mounting thereat respectively.

In addition, the through hole 71B is pre-formed at the circuit board 2B at the enclosed portion thereof in the step (1).

(2) Mold-inject the shell 1B for sealing and enclosing the illuminating unit 4B to form a waterproof casing of the illuminating unit 4B. In the step (2), the chambers 5B are formed on the top side 101B of the shell 1B to align with the diodes 21B.

Preferably, the shell 1B is provided for each of the illuminating units 4B by ABS molding.

In the step (2), during mold-injecting of the shell 1B, the upper portion of the shell 1B is sealed and overlapped on the top side of the circuit board 2B and the bottom portion of the shell 1B is sealed and overlapped on the bottom side of the circuit board 2B in order to seal and enclose the circuit board 2B.

It is worth mentioning that, in the step (2), the sealing portion 241B of each of the wires 24B is also sealed by the sidewall 103B of the shell 1B to ensure the connections between the wires 24b and the circuit board 2B.

(3) Apply the chamber seal 61B for sealing at each of the chambers 5B of the shell to seal and enclose the respective diodes 21B therewithin, wherein each chamber seal 61B protects said corresponding diode 21B within the chamber 5B in a waterproof manner, as shown in FIG. 26.

It is worth mentioning that the chamber seal 61B is arranged for sealing each of the chamber 5B in which the diode 21B is positioned. In other words, the chamber seals 61B not only seal at the chambers 5B to enclose the diodes 21B therewithin but also seal at the exposed portions of the circuit board 2B to protect the exposed portions thereof in a waterproof manner.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A LED illuminating device, comprising:
an illuminating unit which comprises a circuit board, one or more diodes electrically mounted on said circuit board, and a plurality of wires electrically extending from two side edges of said circuit board respectively to electrically connect with said diodes;
a shell sealing and enclosing said illuminating unit to form a waterproof casing of said illuminating unit, wherein said shell has a top side, a bottom side, and one or more chambers indented from said top side to align with said diodes respectively, wherein said shell forms an integrated enclosure to seal said circuit board therewithin at a position that said circuit board is sealed between said top and bottom sides of said shell, and to seal connections between said wires and said circuit board; and
a chamber seal sealing at each of said chambers of said shell to seal and enclose said respective diodes therewithin, wherein each said chamber seal protects said corresponding diode within said chamber in a waterproof manner.

2. The LED illuminating device, as recited in claim 1, wherein said shell is mold-injected to said illuminating unit that an upper portion of said shell is sealed and overlapped on a top side of said circuit board and a bottom portion of said shell is sealed and overlapped on a bottom side of said circuit board in order to seal and enclose said circuit board.

3. The LED illuminating device, as recited in claim 1, wherein said circuit board has an enclosed portion sealed by said shell and one or more exposed portions for said diodes electrically mounting thereat respectively, wherein said chamber seals not only seal at said chambers to enclose said diodes therewithin but also seal at said exposed portions of said circuit board to protect said exposed portions thereof in a waterproof manner.

4. The LED illuminating device, as recited in claim 2, wherein said circuit board has an enclosed portion sealed by said shell and one or more exposed portions for said diodes electrically mounting thereat respectively, wherein said chamber seals not only seal at said chambers to enclose said diodes therewithin but also seal at said exposed portions of said circuit board to protect said exposed portions thereof in a waterproof manner.

5. The LED illuminating device, as recited in claim 1, wherein said chamber seal is made of transparent resin.

6. The LED illuminating device, as recited in claim 4, wherein said chamber seal is made of transparent resin.

7. The LED illuminating device, as recited in claim 1, wherein said shell is made of ABS plastic being mold-injected to seal and enclose said circuit board.

8. The LED illuminating device, as recited in claim 6, wherein said shell is made of ABS plastic being mold-injected to seal and enclose said circuit board.

9. The LED illuminating device, as recited in claim 1, wherein each of said wires has a sealing portion extending from a bottom side of said circuit board and being sealed by said shell, and an extending portion extending out of said shell in such a manner that when said circuit board is sealed and enclosed by said shell, said sealing portions of said wires are also sealed by said shell to ensure said connections between said wires and said circuit board.

10. The LED illuminating device, as recited in claim 8, wherein each of said wires has a sealing portion extending from a bottom side of said circuit board and being sealed by said shell, and an extending portion extending out of said shell in such a manner that when said circuit board is sealed and enclosed by said shell, said sealing portions of said wires are also sealed by said shell to ensure said connections between said wires and said circuit board.

11. The LED illuminating device, a recited in claim 1, wherein said circuit board has a through hole formed thereon, wherein said shell further has a mounting slot extending from said top side to said bottom side and aligning with said through hole of said circuit board when said circuit board is sealed between said top and bottom sides of said shell.

12. The LED illuminating device, a recited in claim 10, wherein said circuit board has a through hole formed thereon, wherein said shell further has a mounting slot extending from said top side to said bottom side and aligning with said through hole of said circuit board when said circuit board is sealed between said top and bottom sides of said shell.

13. A LED illuminating arrangement, comprising a plurality of LED illuminating devices being electrically connected by wires, wherein each of said LED illuminating devices comprises:
an illuminating unit which comprises a circuit board, and one or more diodes electrically mounted on said circuit board, wherein said wires are electrically extending from two side edges of said circuit board respectively to electrically connect with said diodes; and
a shell sealing and enclosing said illuminating unit to form a waterproof casing of said illuminating unit, wherein said shell has a top side, a bottom side, and one or more chambers indented from said top side to align with said diodes respectively, wherein said shell forms an integrated enclosure to seal said circuit board therewithin at a position that said circuit board is sealed between said top and bottom sides of said shell, and to seal connections between said wires and said circuit board; and
a chamber seal sealing at each of said chambers of said shell to seal and enclose said respective diodes therewithin, wherein each said chamber seal protects said corresponding diode within said chamber in a waterproof manner.

14. The LED illuminating arrangement, as recited in claim 13, wherein said shell is mold-injected to said illuminating unit that an upper portion of said shell is sealed and overlapped on a top side of said circuit board and a bottom portion of said shell is sealed and overlapped on a bottom side of said circuit board in order to seal and enclose said circuit board.

15. The LED illuminating arrangement, as recited in claim 14, wherein said circuit board has an enclosed portion sealed by said shell and one or more exposed portions for said diodes electrically mounting thereat respectively, wherein said chamber seals not only seal at said chambers to enclose said diodes therewithin but also seal at said exposed portions of said circuit board to protect said exposed portions thereof in a waterproof manner.

16. The LED illuminating arrangement, as recited in claim 15, wherein said chamber seal is made of transparent resin, wherein said shell is made of ABS plastic being mold-injected to seal and enclose said circuit board.

17. The LED illuminating arrangement, as recited in claim 16, wherein each of said wires has a sealing portion extending from a bottom side of said circuit board and being sealed by said shell, and an extending portion extending out of said shell in such a manner that when said circuit board is sealed and enclosed by said shell, said sealing portions of said wires are also sealed by said shell to ensure said connections between said wires and said circuit board.

18. A method of manufacturing a LED illuminating device, comprising the steps of:
(a) electrically coupling one or more diodes on a circuit board and electrically extending a plurality of wires from said circuit board to electrically link with said diodes in order to form an illuminating unit;
(b) mold-injecting a shell sealing and enclosing said illuminating unit to form a waterproof casing of said illuminating unit, wherein said shell has a top side, a bottom side, and one or more chambers indented from said top side to align with said diodes respectively, wherein said shell forms an integrated enclosure to seal said circuit board therewithin at a position that said circuit board is sealed between said top and bottom sides of said shell, and to seal connections between said wires and said circuit board; and
(c) applying a chamber seal for sealing at each of said chambers of said shell to seal and enclose said respective diodes therewithin, wherein each said chamber seal protects said corresponding diode within said chamber in a waterproof manner.

19. The method as recited in claim 18 wherein, in the step (b), during mold-injecting of said shell, an upper portion of said shell is sealed and overlapped on a top side of said circuit board and a bottom portion of said shell is sealed and overlapped on a bottom side of said circuit board in order to seal and enclose said circuit board.

20. The method as recited in claim 19 wherein the step (a) further comprises a step of configuring said circuit board to have an enclosed portion sealed by said shell and one or more exposed portions for said diodes electrically mounting thereat respectively, wherein said chamber seals not only seal at said chambers to enclose said diodes therewithin but also seal at said exposed portions of said circuit board to protect said exposed portions thereof in a waterproof manner.

21. The method, as recited in claim 20, wherein said chamber seal is made of transparent resin, wherein said shell is made of ABS plastic being mold-injected to seal and enclose said circuit board.

22. The method, as recited in claim 21, wherein the step (b) further comprises a step of sealing a sealing portion of each of said wires, wherein said sealing portion of said wire is extending from a bottom side of said circuit board and being sealed by said shell, and an extending portion of said wire is extending out of said shell in such a manner that when said circuit board is sealed and enclosed by said shell, said sealing portions of said wires are also sealed by said shell to ensure said connections between said wires and said circuit board.
